(19) United States
(12) Patent Application Publication
(10) Pub. No.: US 2026/0116153 A1
(43) Pub. Date: Apr. 30, 2026

(54) Air Diffuser for a Vehicle with an Actuator for Manipulating an Air Flow Regulating and/or Air Flow Deflecting Element as Required

(71) Applicant: Illinois Tool Works Inc., Glenview, IL (US)

(72) Inventor: Günther Krämer, Enkenbach-Alsenborn (DE)

(21) Appl. No.: 19/373,243

(22) Filed: Oct. 29, 2025

(30) Foreign Application Priority Data
Oct. 31, 2024 (DE) 102024131912.7

(51) Int. Cl. B60H 1/34

(52) U.S. Cl. CPC B60H 1/3414; B60H 2001/3471

(57) ABSTRACT

The disclosure relates to an air vent (1) for a motor vehicle, wherein the air vent (1) comprises a housing (2) and at least one air stream-regulating and/or air stream-deflecting element (5), which is accommodated at least partially or regionally in the housing (2) and is mounted in a movable, and in particular a pivotable, manner relative to the housing (2) in order to deflect as needed, at least at an air outlet of the air vent (1), an air stream flowing through the air duct from a main flow direction and/or a quantity of air flowing out of the air outlet of the air vent (1) per unit of time. According to the disclosure, it is provided in particular that the at least one air stream-regulating and/or air stream-deflecting element (5) is associated with at least one actuator (6) for as-needed manipulation of the at least one air stream-regulating and/or air stream-deflecting element (5), wherein the at least one actuator (6) is designed as an in particular module-like unit that can be at least partially or regionally integrated in the housing (2) or attached to the housing (2), being in particular releasably or exchangeably attached or attachable thereto.

### RELATED APPLICATIONS

The present application claims the benefit of German Patent Application No. 102024131 912.7, filed October 31, 2024, titled “Air Diffuser for a Vehicle with an Actuator for Manipulating an Air Flow Regulating and/or Air Flow Deflecting Element as Required,” the contents of which are hereby incorporated by reference.

### BACKGROUND

In ventilation apparatuses for vehicles, air vents or air vent nozzles are typically used, which enable the exiting air stream to be controlled in a targeted manner. Such air vents are used in order to supply fresh air, in particular, into a motor vehicle interior.

The air stream flows through an inlet opening at an air inlet region of the air vent into the air duct, which is delimited by the housing wall of the air vent, through said air duct, and ultimately through an outlet opening at the air outlet region of the air vent into the interior of a motor vehicle (for example, a car or truck). The air stream generally follows a main flow direction, which can run in particular at least substantially parallel to a longitudinal axis of the housing of the air vent.

In known air vents, the air stream is deflected from the main flow direction by one or more air guiding elements, for example pivotable air guiding blades or fixed air guiding elements. In addition to the air guiding elements, the housing of the air vent that delimits the air duct can also serve to deflect the air from the main flow direction.

A special design of air vents is in the form of corresponding “ball vents.” Here, an air guiding insert arranged in the housing of the air vent is used, wherein the air guiding insert comprises a bearing body that is pivotably supported in the housing in the manner of a ball-and-socket joint. Such ball vents can also optionally comprise an aperture mounted rotatably on the bearing body and a plurality of blades, wherein the blades can be adjusted about a pivot axis arranged radially with respect to the air guiding insert.

In particular, the region of an air vent that is visible from the interior of the motor vehicle, such as, in particular, the air outlet region of the housing, is increasingly used in order to generate attention among consumers and to enhance the overall appearance of the motor vehicle. In particular, the interior furnishing of a motor vehicle is an increasingly distinguishing feature and should be designed in order to create style and ambience as desired by the motor vehicle buyer.

An existing desire in the technical world is in particular to specify as compact an air vent as possible, which allows for an advantageous adjustability of the air vent despite a reduction of the design space.

The problem addressed by the disclosure is based on the fact that the degree of possible miniaturization of the air stream-regulating and/or air stream-deflecting elements of the air vent for as-needed manipulation generally cannot be expanded as desired. One reason for this problem is the size of an actuator corresponding to the air vent, for example a linear drive, with which the air stream-regulating and/or air stream-deflecting elements of the air vent are actuated as needed. In order to ensure that a sufficiently high force can be produced with the actuator, which is frequently implemented as a linear drive, the actuators used thus far, which are typically electric motors, must necessarily have a certain minimum size.

In light of this situation, the present disclosure addresses the problem of specifying an optimized air vent in which nearly any desired miniaturization of the air stream-regulating and/or air stream-deflecting elements for as-needed manipulation is possible, in order to be able to realize the particularly small design of the air vent.

A further disadvantage of the air vent known from the prior art can be seen in that different customer requirements can necessitate different configurations of air vents due to varying applications. The sometimes specific and different customer requirements produce a relatively high number of variants in relation to the individual part level up to the entire air vent. This relates in particular to the manipulation of the air stream-regulating and/or air stream-deflecting elements of the air vent. This results in cost disadvantages due to high logistics costs, production costs, high set-up costs, small batches, and variant formation at the start of the value chain.

The disclosure is thus also intended to solve the problem so that an air vent can be designed as variably as possible in view of the desired as-needed manipulation of the air stream-regulating and/or air stream-deflecting elements.

### SUMMARY OF THE DISCLOSURE

The present disclosure relates generally to a ventilation system, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates schematically and in a sectional view, a region of an exemplary embodiment of the air vent according to the disclosure.

FIG. 2 illustrates schematically and in a sectional view, a region of a further exemplary embodiment of the air vent according to the disclosure.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The problem addressed by the disclosure is solved by an air vent according to the independent claim 1, wherein advantageous further developments of the air vent according to the disclosure are specified in the dependent claims.

Accordingly, the disclosure relates in particular to an air vent for a motor vehicle, wherein the air vent comprises a housing having an air inlet region and an air outlet region, wherein an air duct is formed at least partially or regionally through the housing. The air vent further comprises at least one air stream-regulating and/or air stream-deflecting element, which is accommodated at least partially or regionally in the housing and is mounted in a movable, and in particular a pivotable, manner relative to the housing in order to deflect as needed, at least at an air outlet of the air vent, an air stream flowing through the air duct from a main flow direction and/or a quantity of air flowing out of the air outlet of the air vent per unit of time.

According to the disclosure, it is provided in particular that at least one actuator is associated with the at least one air stream-regulating and/or air stream-deflecting element for as-needed manipulation of the at least one air stream-regulating and/or air stream-deflecting element. The at least one actuator is configured in particular as a modular unit. According to the disclosure, it is provided in particular that the modularly designed unit or the at least one actuator is at least partially or regionally integrated in the housing or mounted on the housing, being in particular releasably or exchangeably attached or attachable thereto, for the as-needed manipulation of the at least one air stream-regulating and/or air stream-deflecting element.

In particular, the air vent is characterized by its modular construction in view of the at least one actuator for the as-needed manipulation of the at least one air stream-regulating and/or air stream-deflecting element.

The modular structure, in particular of the actuator device of the air vent according to the disclosure, makes it possible to make adjustments, optimizations and also cost reductions in the actuator system of the air vent without the typical “ripple effect” of changes within the entire air vent. The modularization of the air vent provided in view of the actuator assembly reduces product complexity and makes the customer order process more efficient by allowing the air vent to be configured specifically to the order instead of being designed specifically to the order.

In other words, the air vent according to the disclosure is constructed, at least in view of the actuator assembly for the as-needed manipulation of the air stream-regulating and/or air stream-deflecting elements of the air vent, in a modular principle, wherein the functional components of the air vent and/or the actuator system can be subdivided into modules or assemblies. The individual modules or assemblies of the actuator system can be joined together or integrated via appropriate interfaces, if the form and function are suitable.

The at least one actuator of the air vent according to the present disclosure can be a stepper motor, a brushless DC motor, or a DC motor.

However, in order to enable miniaturization of the actuator system, it is also contemplated to provide an entirely new approach for as-needed actuation of the air stream-regulating and/or air stream-deflecting elements. By contrast to a classical motor as an actuator, which, due to its operating principle, requires a certain minimum size, the at least one actuator of the air vent can be designed as a functional unit consisting of a material that is provided in such a way that it reversibly changes its dimensions in a preferred direction of the material or the functional unit upon supply of energy (heat, electrical energy, light, etc.).

In this context, for example, it is contemplated that the at least one functional unit of the actuator consists of a material having shape-memory properties, and wherein the functional unit is configured to reversibly change its dimensions in the preferred direction of the functional unit upon a supply of heat. By changing the dimensions of the functional unit, a force is thus generated that is used, directly or indirectly, to actuate or manipulate the at least one air stream-regulating and/or air stream-deflecting element.

Materials having shape-memory properties, such as shape-memory polymers or shape-memory alloys, are those materials that can change shape from a fixed, temporarily occupied shape to an originally taken (permanent) shape upon heating above a transition temperature or in response to another external stimulus. The material is first brought to its permanent shape with conventional treatment methods. The material is then deformed and fixed in the desired temporary form. This process is also referred to as “programming.”

For example, programming can include a heating of the material, a high temperature deformation, and a cooling operation or a low temperature deformation (“cold stretching”). The permanent shape is now saved while the temporary shape is currently in place. By heating the material to a temperature above the transition temperature, the shape-memory effect is triggered and thus the permanent shape is reconstituted.

In order for the at least one functional unit with the shape-memory material to also be able to be cyclically utilized, it is provided according to a further development of the present disclosure that a first electrode unit and a second electrode unit are associated with the functional unit, wherein a polymer layer is arranged between the first and the second electrode unit, which comprises a dielectric elastomer having shape-memory properties. Furthermore, a control unit is provided, which contacts the first and second electrode units. The control unit is configured to apply an electrical voltage between the first and second electrode units, and further to allow an electrical current to flow through the first and/or second electrode units.

In this embodiment, two properties of the polymer layer used are utilized, which can be realized by different actuation of the electrodes. When an electrical current flows through the first and/or second electrode units, a resistive heating is realized. In this way, the polymer can be heated for programming. The actual programming takes place by applying an electrical voltage and thus an electrical field between the first and the second electrode units. In this case, the dielectric elastomer or the corresponding functional unit is deformed. After taking on the temporary form, the polymer is activated by in turn passing an electrical current through the first and/or second electrode units, and thus the polymer is heated. These operations can be repeated so that a cyclical use of the shape-memory polymer as a functional unit of the actuator is enabled.

However, the present disclosure is not limited to actuators in which the at least one functional unit has a dielectric elastomer or polymer with shape-memory properties. Rather, it is contemplated that the at least one functional unit will also work with shape-memory alloys in a corresponding manner. For this purpose, the at least one functional unit can be configured as a tubular monolithic SMA actuator produced from a tubular monolithic SMA substrate of, for example, NiTi, CuAlNi, CuAl, CuZnAl, TiV or TiNb.

The functional unit configured as a tubular monolithic SMA actuator can have a first end, a second end, and a middle portion and can be obtained from a substrate having, for example, a circular, elliptical, rectangular, or irregular cross-section. The middle portion forms an actuator template which preserves its uniformity and electrical conductivity in the course of the template from the first end to the second end. The actuator template can be any template. For example, it can be a meandering pattern or a zigzag pattern. A first electrode can be formed at the first end and a second electrode can be formed at the second end of the actuator.

In a method for operating such an actuator, an electrical current is applied to the actuator, which heats the actuator and in this way results in bending of the actuator.

Alternatively, however, it is also contemplated that the at least one functional unit of the actuator system is formed from a material having piezoelectric properties, wherein the functional unit is configured to reversibly change its dimensions in the preferred direction of the functional unit when an electrical voltage is applied, to generate a force in this way, which can be used in order to actuate the at least one air stream-regulating and/or air stream-restricting element of the air vent.

According to embodiments of the actuator system according to the disclosure, the at least one functional unit comprises an elastic soft polymer core between two flexible electrodes. If there is an electrical voltage between the two flexible electrodes, the two electrodes will attract one another and will squeeze the soft polymer core between one another. Because polymers are virtually non-compressible, the elastomeric material expands laterally as a result. In this case, this lateral expansion corresponds to a change in the dimensions of the functional unit in the preferred direction, so that the force generated thereby can be used in order to actuate at least one air stream-regulating and/or air stream-restricting element of the air vent.

If the electric voltage between the two flexible electrodes now drops, the sandwich returns to its original form. In other words, the at least one functional entity will contract and take on its original form.

In a similar implementation of the actuator system according to the disclosure, a functional unit made of elastic plastic is used, which regains its original design after deformation (elastomer). Alternatively, however, it is also contemplated to form the functional unit from thin, very flexible polymer plastic films, wherein these films are filled with, for example, electrically non-conductive (insulative) liquids. This results in a hydraulic element that is coated with a gel that is very ductile and conducts electrical charges. For example, this can be a gel swollen in salt water.

Now, when the hydraulic element is placed under electrical voltage, an electrical field is built up that penetrates the various layers of the hydraulic element and imparts an electrostatic force on the fluid. As a result, the soft shell of the hydraulic element is deformed, and movements result and/or forces are generated that can be used in order to actuate the at least one air stream-regulating and/or air stream-restricting element of the air vent.

All of the embodiments described above have in common that the functional unit can be extremely small and can be designed to be very flexible in terms of its dimensions. Thus, functional units are contemplated in the millimeter size range or less.

This allows the entire drive system of the air vent to be miniaturized. On the other hand, the functional units are nonetheless configured to generate a sufficiently high force, in particular when a plurality of interoperable functional units are used.

To increase the force that can be generated by the actuator system, according to implementations of the present disclosure, it is provided that a plurality of functional units are connected in series in their respective preferred direction in order to thus form a fibrous or strand-like functional group. Upon a supply of energy, all functional units of a functional group can be activated so that the motion stroke of the functional group generated thereby is composed of a sum of all individual motion strokes of the individual functional units of the functional group.

Alternatively or additionally, it is contemplated that at least two functional units are arranged parallel to one another such that, upon a supply of energy, the total force generated by the at least two functional units arranged parallel to one another corresponds to a sum of the individual forces that can be generated by the at least two functional units upon a supply of energy.

By optionally connecting the individual functional units in series or in parallel, the actuator system can thus be specially adapted to the respective application. Also, finely metered forces can be generated with the actuator system.

In this context, for example, it is also contemplated that the at least one actuator comprises a first group of functional units and a second group of functional units, wherein the first and second groups are each independently actuatable by a respective supply of energy to the functional units of the respective group. For example, the functional units of the first group are configured to contract upon a supply of energy in the preferred direction of the respective functional unit, wherein the functional unit of the second group is configured to expand upon a supply of energy in the preferred direction of the respective functional unit.

According to preferred realizations of the air vent according to the disclosure, the at least one actuator is associated with a clutch, via which an output element, in particular an output shaft, of the actuator is or can be operatively connected to the air stream-regulating and/or air stream-deflecting element which is to be manipulated as needed. The clutch is preferably a self-actuated torque-shifting safety clutch, in particular in the form of a slip clutch.

In this context, in particular, it can be appreciated that a position sensor system is associated with the clutch in order to at least indirectly detect a position of the at least one air stream-regulating and/or air stream-deflecting element of the air vent.

Preferably, the control unit associated with the actuator is also designed to be as space-saving as possible and is arranged or integrated in or on the housing of the air vent. It can be appreciated that the actuator is associated with a control unit, in particular in the form of a micro-controller, which is arranged on an in particular flexible conductor track or printed circuit board. In this context, the in particular flexible conductor track or printed circuit board should also comprise contacting ports, via which contact terminals of the actuator are or can be galvanically connected to the control unit.

In particular, the at least one actuator and, if applicable, the clutch associated with the actuator are arranged inside the housing of the air vent. Alternatively or additionally, the at least one actuator can also be arranged or integrated in a cover of the housing. However, it is also contemplated in the case of design variants that the at least one actuator is arranged in the region of a housing edge of the air vent.

According to implementations of the air vent according to the disclosure, it is provided that at least one actuator is associated with a housing half-shell, which can be connected to a wall region of the housing of the air vent, preferably via a clip and/or catch connection, in such a way that an actuator housing defined on one side by the housing half-shell of the actuator and on the other side by the wall region of the housing is or can be formed.

In this respect, it can be appreciated that, in the actuator housing, the at least one actuator, preferably with a/the clutch and/or further preferably with a control unit, is or can be received at least regionally.

The advantages achievable with this embodiment of the air vent according to the disclosure are obvious: by providing that the air vent does not have a “complete” housing for receiving the actuator, but rather only includes a housing half shell, wherein said housing half shell is connected, preferably detachably and in particular via a clip and/or catch connection, to the main body of the housing of the air vent in order to form a complete housing, significant design space savings can be achieved. The disclosure is in particular based on the finding that a in particular compact design of the illumination module can be realized by the fact that a wall region of the main body of the housing of the air vent is also used in order to form the housing for receiving the light source support.

This in particular allows the actuator to be used as an actuator module “on site,” i.e., in the immediate vicinity of the air stream-regulating or air stream-deflecting element of the air vent, which is to be manipulated as needed, without the use of an expensive clutch between the actuator and the air stream-regulating or air stream-deflecting element of the air vent.

In other words, the actuator module according to the disclosure can be connected to the base body of the housing of the air vent that is to be manipulated in the immediate vicinity of the air stream-regulating or air stream-deflecting element of the air vent without a significant additional design space being required for the integration of the actuator module.

In this way, cost savings can be realized due to the simplified design and simplified mounting capability of the actuator.

In particular, the actuator module according to the disclosure is suitable as a standard component for the as-needed manipulation of the air stream-regulating or air stream-deflecting element of the air vent.

In design variants of the air vent according to the disclosure, a plug-in connection module is arranged preferably releasably on the housing half-shell, via which the at least one actuator is or can be connected in a signaling or controlling manner, wherein the plug-in connection module 11 is preferably arranged outside of the actuator housing.

The embodiments of the air vent 1 according to the disclosure shown schematically in the drawings each comprise a housing 2 having an air inlet region 3 and an air outlet region 4, wherein an air duct is formed at least partially or regionally by the housing 2. The embodiments of the air vent 1 according to the disclosure as shown schematically in the drawings further comprise in each case at least one air stream-regulating and/or air stream-deflecting element 5, which is accommodated at least partially or regionally in the housing 2 and is mounted in a movable, and in particular a pivotable, manner relative to the housing 2 in order to deflect as needed, at least at an air outlet of the air vent 1, an air stream flowing through the air duct from a main flow direction and/or a quantity of air flowing out of the air outlet of the air vent 1 per unit of time.

The embodiments of the air vent 1 according to the disclosure as shown schematically in the drawings are characterized in particular in that the at least one air stream-regulating and/or air stream-deflecting element 5 is associated with at least one actuator 6 for as-needed manipulation of the at least one air stream-regulating and/or air stream-deflecting element 5, wherein the at least one actuator 6 is designed as an in particular module-like unit that can be at least partially or regionally integrated in the housing 2 or attached to the housing 2, being in particular releasably or exchangeably attached or attachable thereto.

It can be seen that the at least one actuator 6 comprises a stepper motor, a brushless DC motor, and/or a DC motor. However, other design variants are also contemplated, in particular those in which the at least one actuator 6 comprises at least one functional unit, which is configured to reversibly change its dimensions in a preferred direction of the functional unit upon a supply of energy.

In the embodiments of the air vent 1 according to the disclosure as shown schematically in the drawings, it is further provided that the at least one actuator 6 is associated with a clutch 7, via which an output element, in particular an output shaft, of the actuator 6 is or can be operatively connected to the air stream-regulating and/or air stream-deflecting element 5 which is to be manipulated as needed.

In particular, the clutch 7 is configured as a self-actuated torque-shifting safety clutch, in particular in the form of a slip clutch.

Although not explicitly shown, it is advantageous for a position sensor system to be associated with the clutch 7 for detecting a position of the air stream-regulating and/or air stream-deflecting element 5.

Furthermore, it is preferred that a control unit 10, in particular in the form of a micro-controller, is associated with the actuator 6 and is arranged on an in particular flexible conductor track or printed circuit board, wherein the in particular flexible conductor track or printed circuit board comprises contact ports, via which contact terminals of the actuator 6 are or can be galvanically connected to the control unit 10.

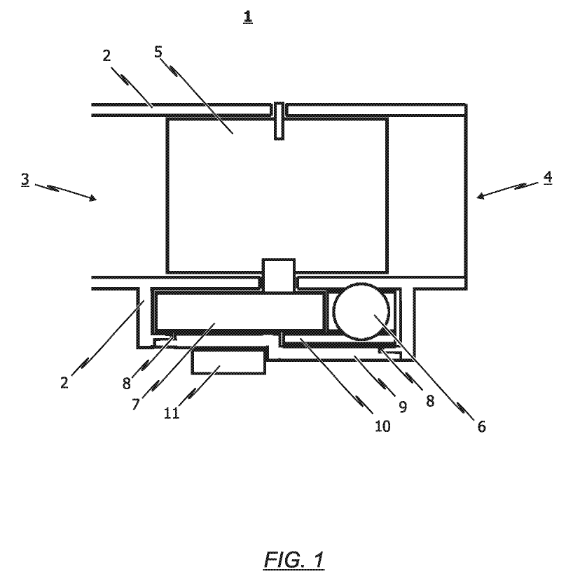

In the embodiment of the air vent 1 according to the disclosure as shown in FIG. 1, the at least one actuator 6 with the clutch 7 and the control unit 10 is arranged or integrated in a cover of the housing 2.

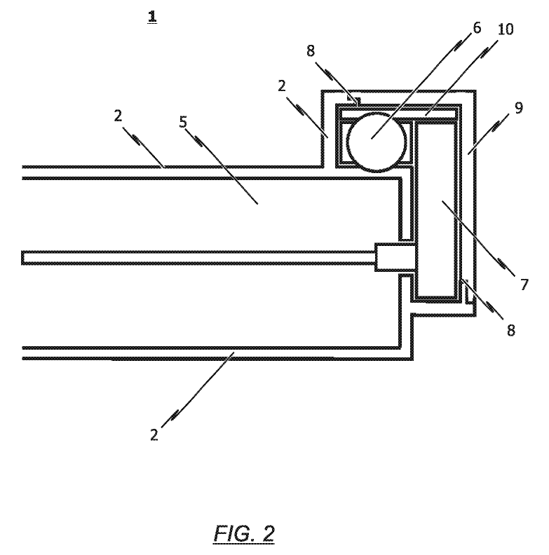

In the embodiment of the air vent 1 according to the disclosure as shown in FIG. 2, by contrast, the at least one actuator 6 with the clutch 7 and the control unit 10 is arranged or integrated in the region of a housing edge of the housing 2.

Specifically, it is provided that at least one actuator 6 with the clutch 7 and the control unit 10 is associated with a housing half-shell 9, which can be connected to a wall region of the housing 2 of the air vent 1, preferably via a clip and/or catch connection 8, in such a way that a housing defined on one side by the housing half-shell 9 of the actuator 6 and on the other side by the wall region of the housing 2 is or can be formed.

The at least one actuator 6 with the clutch 7 and the control unit 10 is or can be received at least regionally in the housing.

It can further be seen that a plug-in connection module 11 is arranged preferably releasably on the housing half-shell 9, via which the at least one actuator 6 is or can be connected in a signaling or controlling manner, wherein the plug-in connection module 11 is arranged outside of the actuator housing.

The exemplary embodiments of the air vent 1 according to the disclosure as shown in the drawings are characterized in particular by the free arrangement of the drive components/actuator 6 in order to thus ensure an optimized usage of the installation space. In particular, the corresponding drive unit is directly integrated in the vent housing 2.

### Description of functional principle:

Air vent 1 according to FIG. 1 with implementation of a modular actuator 6. The actuator 6 contains a number of assemblies that can be arranged as needed, e.g. according to the range of installation spaces, and can be integrated directly into the housing 2 of the vent 1. With a shield or a housing lid, the drive unit 6 is enclosed and protected against environmental influences.

With such a concept, a variety of needs-based arrangements are possible. An actuator 6 can be adapted to the contour of a housing 2, for example, and thus make decisive use of installation space advantages.

An actuator 6 can thus also be fed around a housing edge, see FIG. 2.

To connect the electrical components, for example, a flexible conductor track can be designed with integrated electronic components in such a way that a versatile use of the same is possible.

Corresponding connection options are available on the market and also permit automation of the assembly process.

To complete the drive unit, the drive elements are advantageously arranged either in the vent housing 2 or in the cover of the actuator and advantageously fixed therein.

Upon closing with a cover/housing half-shell 9 during the pre-assembly in the housing 2 or upon joining to the housing 2 during the pre-assembly in the cover/housing half-shell 9, the actuator 6, which is protected against external influences, is produced.

The following summarizes some aspects of the disclosure: largely free arrangement of the drive components of an actuator 6 on a vent housing 2 for optimum usage of the installation space and the advantageous arrangement proximate to the driven air-deflecting element 5, in particular in tight installation spaces; the drive components can be arranged in the housing 2 of the vent 1; the drive components can be arranged in the cover of the motor housing integrated in the housing of the vent; the arrangement of the drive components can be designed around a housing edge; the power source/actuator 6 can be a stepper motor, a BLDC motor, or a DC motor; the force source can be a shape-memory actuator; a clutch to the air-deflecting element can be a slip clutch; the electronic components and contacts can be arranged on a flexible printed circuit board; the clutch to the air-deflecting element can include a position sensor system, in particular if the clutch to the air-deflecting element is a slip clutch; the slip clutch can allow for manual overwriting of the motor function; and/or the slip clutch can contain a driver.

While the present method and/or system have been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### List of reference numerals

1 Air vent

2 Housing

3 Air inlet region

4 Air outlet region

5 Air stream-regulating/air stream-deflecting element

6 Actuator

7 Coupling/transmission

8 Clip and/or catch connection

9 Housing half-shell

10 Control unit

11 Plug-in connection module

What is claimed is:

1. An air vent (1) for a motor vehicle, wherein the air vent (1) comprises:
a housing (2) having an air inlet region (3) and an air outlet region (4), wherein an air duct is formed at least partially or regionally by the housing (2); and
at least one air stream-regulating and/or air stream-deflecting element (5), which is accommodated at least partially or regionally in the housing (2) and is mounted in a movable, and in particular a pivotable, manner relative to the housing (2) in order to deflect as needed, at least at an air outlet of the air vent (1), an air stream flowing through the air duct from a main flow direction and/or a quantity of air flowing out of the air outlet of the air vent (1) per unit of time,
wherein the at least one air stream-regulating and/or air stream-deflecting element (5) is associated with at least one actuator (6) for as-needed manipulation of the at least one air stream-regulating and/or air stream-deflecting element (5), wherein the at least one actuator (6) is designed as an in particular module-like unit that can be at least partially or regionally integrated in the housing (2) or attached to the housing (2), being in particular releasably or exchangeably attached or attachable thereto.

2. The air vent (1) according to claim 1, wherein the at least one actuator (6) comprises a stepper motor, a brushless DC motor, and/or a DC motor.

3. The air vent (1) according to claim 1, wherein the at least one actuator (6) comprises at least one functional unit, which is configured to reversibly change its dimensions in a preferred direction of the functional unit upon a supply of energy.

4. The air vent (1) according to claim 3, wherein the at least one functional unit is formed from a material having shape-memory properties, and wherein the functional unit is configured to reversibly change its dimensions in the preferred direction of the functional unit upon a supply of heat.

5. The air vent (1) according to claim 4, wherein the material is or comprises a dielectric elastomer, a dielectric polymer, or a metal alloy, in particular nitinol.

6. The air vent (1) according to claim 3, wherein the at least one functional unit is formed from a material having piezoelectric properties, and wherein the functional unit is configured to reversibly change its dimensions in the preferred direction of the functional unit when an electrical voltage is applied.

7. The air vent (1) according to claim 3, wherein the at least one functional unit is formed from a material based on electroactive polymers, and wherein the functional unit is configured to reversibly change its dimensions in the preferred direction of the functional unit when an electrical voltage is applied.

8. The air vent (1) according to claim 3, wherein the at least one functional unit comprises a hydraulic element (5) consisting of a plurality of flexible polymer films filled with an electrically non-conductive liquid, and wherein the hydraulic element (5) is coated with a ductile and electrically conductive gel.

9. The air vent (1) according to claim 3, wherein a plurality of functional units are connected in series, each in their preferred direction, to form a fibrous or strand-like functional group, wherein, upon a supply of energy, all functional units of a functional group can be activated so that the motion stroke of the functional group generated thereby is composed of a sum of all individual motion strokes of the individual functional units of the functional group.

10. The air vent (1) according to claim 3, wherein at least two functional units are arranged parallel to one another such that, upon a supply of energy, the total force generated by the at least two functional units arranged parallel to one another corresponds to a sum of the individual forces that can be generated by the at least two functional units upon a supply of energy.

11. The air vent (1) according to claim 3, wherein the at least one actuator (6) comprises a first group of functional units and at least a second group of functional units, wherein the first and second groups are each independently actuatable by a respective supply of energy to the functional units of the respective group.

12. The air vent (1) according to claim 11, wherein the functional units of the first group are configured to contract upon a supply of energy in the preferred direction of the respective functional unit, and wherein the functional units of the at least one second group are configured to expand upon a supply of energy in the preferred direction of the respective functional unit.

13. The air vent (1) according to claim 3, wherein at least one functional unit is configured as a passive sensor unit, which is designed to output a corresponding electrical signal depending on a change in the dimensions of the functional unit in its preferred direction.

14. The air vent (1) according to claim 1, wherein the at least one actuator (6) is associated with a clutch (7), via which an output element, in particular an output shaft, of the actuator (6) is or can be operatively connected to the air stream-regulating and/or air stream-deflecting element (5) which is to be manipulated as needed.

15. The air vent (1) according to claim 14, wherein the clutch (7) is configured as a self-actuated torque-shifting safety clutch, in particular in the form of a slip clutch.

16. The air vent (1) according to claim 14,
wherein a position sensor system is associated with the clutch (7) for detecting a position of the air stream-regulating and/or air stream-deflecting element (5).

17. The air vent (1) according to claim 1, wherein a control unit (10), in particular in the form of a micro-controller, is associated with the actuator (6) and is arranged on an in particular flexible conductor track or printed circuit board, wherein the in particular flexible conductor track or printed circuit board comprises contact ports, via which contact terminals of the actuator (6) are or can be galvanically connected to the control unit (10).

18. The air vent (1) according to claim 1,
wherein the at least one actuator (6) is arranged inside the housing (2); or
wherein the at least one actuator (6) is arranged or integrated in a cover of the housing (2); or
wherein the at least one actuator (6) is arranged or integrated in the region of a housing edge of the housing (2).

19. The air vent (1) according to claim 1, wherein the at least one actuator (6) is associated with a housing half-shell (9), which can be connected to a wall region of the housing (2) of the air vent (1), via a clip and/or catch connection (8), in such a way that an actuator housing defined on one side by the housing half-shell (9) of the actuator (6) and on the other side by the wall region of the housing (2) is or can be formed.

20. The air vent (1) according to claim 19, wherein, in the actuator housing, the at least one actuator (6) is or can be received at least regionally and includes at least one of a clutch (7) or a control unit (10).
